(19) United States
(12) Patent Application Publication
(10) Pub. No.: US 2018/0176662 A1
(43) Pub. Date: Jun. 21, 2018

(54) DATA COMMUNICATION APPARATUS FOR A KITCHEN APPLIANCE

(71) Applicant: FRYMASTER L.L.C., Shreveport, LA (US)

(72) Inventors: Linda BRUGLER, Shreveport, LA (US); Himanshu Chandrakant PARIKH, Coconut Creek, FL (US); Stephen BURNS, Linden, TX (US); Ozgur TANER, Shreveport, LA (US); Gopinath SOMASUNDARAM, Saidapet (IN); Muthu Ganesan NAMASIVAYAM, Kilpauk Garden (IN)

(21) Appl. No.: 15/385,433

(22) Filed: Dec. 20, 2016

(51) Int. Cl. H04Q 9/00; H04L 29/08; H04L 12/40; G06F 17/21; G06F 17/22

(52) U.S. Cl. CPC H04Q 9/00; H04L 67/02; H04L 12/2825; G06F 17/212; G06F 17/2247; H04L 12/4011

(57) ABSTRACT

There is provided a data communication apparatus adapted for use with a kitchen appliance. The communication apparatus includes (a) a bus interface that is adapted for connection to a bus within the kitchen appliance, (b) a network interface that is addressable at an address in a network, (c) a processor, and (d) a memory that contains instructions that are readable by the processor to cause the processor to (i) receive, via the bus interface, raw data that represents an operating parameter of the kitchen appliance, (ii) receive a request from a user device via the network interface, (iii) convert the raw data into formatted data, (iv) incorporate the formatted data into a page that is presentable on the user device via a web browser that is installed in the user device, and (v) send the page to the user device via the network interface.

### COPYRIGHT NOTICE

A portion of the disclosure of this patent document contains material that is subject to copyright protection. The copyright owner has no objection to reproduction, by anyone, of the patent document or the patent disclosure, as it appears in the Patent and Trademark Office patent files or records, but otherwise reserves all copyrights.

### BACKGROUND OF THE DISCLOSURE

### 1. Field of the Disclosure

The present disclosure relates to appliances such as those used for food preparation in a restaurant or a large-scale food production establishment, and more specifically, a data communication apparatus for monitoring an operation of the appliance, and providing to a maintenance person, information concerning the operation.

### 2. Description of the Related Art

The approaches described in this section are approaches that could be pursued, but not necessarily approaches that have been previously conceived or pursued. Therefore, the approaches described in this section may not be prior art to the claims in this application and are not admitted to be prior art by inclusion in this section.

A commercial kitchen appliance, for example as may be found in a restaurant, may include components whose state or condition is indicative of whether the appliance is operating normally. Local monitoring, e.g., by personnel who work in the restaurant, is almost always necessary. However, it is also desirable to monitor the components from a remote location.

U.S. Pat. No. 7,877,291 to Koether et al. (hereinafter “the '291 patent”) describes a communication network that purportedly has an ability to monitor and control the maintenance, repair and energy management of kitchen or restaurant appliances located over a wide geographical area. Maintenance and repair are monitored through a control center that contains the necessary software diagnostics, accounting records, inventory records, and maintenance records for the particular appliance under service. The '291 patent does not describe an appliance as having a device installed within, to analyze data, configure a report, and send the report to a user device in a user-friendly format for presentation via a general-purpose browser.

### SUMMARY OF THE DISCLOSURE

There is need for a commercial kitchen appliance that includes a capability to analyze data concerning operation of the appliance, configure a report, and send the report to a user device in a user-friendly format for presentation via a general-purpose browser. Since the user device presents the report via its general-purpose browser, the user device does not need to have a special-purpose application installed therein, but instead, can be any device that includes and operates with a general-purpose Internet browser.

This need is accommodated by a kitchen appliance that includes (1) a sensor that senses an operating parameter of a component in the kitchen appliance, thus yielding sensory data, (2) a controller that receives the sensory data, and based thereon, produces a control signal that controls the component, (3) a network interface that is addressable at an address in a network, and (4) a processor that (a) converts the sensory data and the control signal into formatted data, and (b) in response to a request that is received from a user device via the network interface (i) prepares a page that includes the formatted data, for a web browser that is installed in the user device, and (ii) sends the page to the user device via the network interface.

There is thus also provided a data communication apparatus adapted for use with a kitchen appliance. The communication apparatus includes (a) a bus interface that is adapted for connection to a bus within the kitchen appliance, (b) a network interface that is addressable at an address in a network, (c) a processor, and (d) a memory that contains instructions that are readable by the processor to cause the processor to (i) receive, via the bus interface, raw data that represents an operating parameter of the kitchen appliance, (ii) receive a request from a user device via the network interface, (iii) convert the raw data into formatted data, (iv) incorporate the formatted data into a page that is presentable on the user device via a web browser that is installed in the user device, and (v) send the page to the user device via the network interface.

### BRIEF DESCRIPTION OF THE DRAWINGS

FIG. 1 is a block diagram of a system for monitoring an operation of an appliance.

FIG. 1A is a block diagram of components on a memory that is part of the system of FIG. 1.

FIG. 2 is another block diagram of the system of FIG. 1, and shows some additional details of a data communications apparatus.

FIG. 3 is a block diagram of a webserver application.

FIG. 4 is a flow diagram of operations performed by a component of the webserver application of FIG. 3.

FIG. 5 is an illustration of the data communications apparatus being employed in a deep fat fryer.

FIG. 6 is a screen shot of a user interface, showing cooking information per vat in a frypot.

FIG. 7 is a screen shot of a user interface, showing cooking information by product.

FIG. 8 is a screen shot of a user interface, showing filter information.

FIG. 9 is a screen shot of a user interface, showing energy information.

FIG. 10 is a screen shot of a user interface, showing oil information.

FIG. 11 is a table of variables for an example of a calculation of cooks per lb. of oil.

FIG. 12 is a screen shot of a user interface, showing fryer performance information.

FIG. 13 is a screen shot of a user interface, showing Total Polar Materials (TPM).

A component or a feature that is common to more than one drawing is indicated with the same reference number in each of the drawings.

### DESCRIPTION OF THE DISCLOSURE

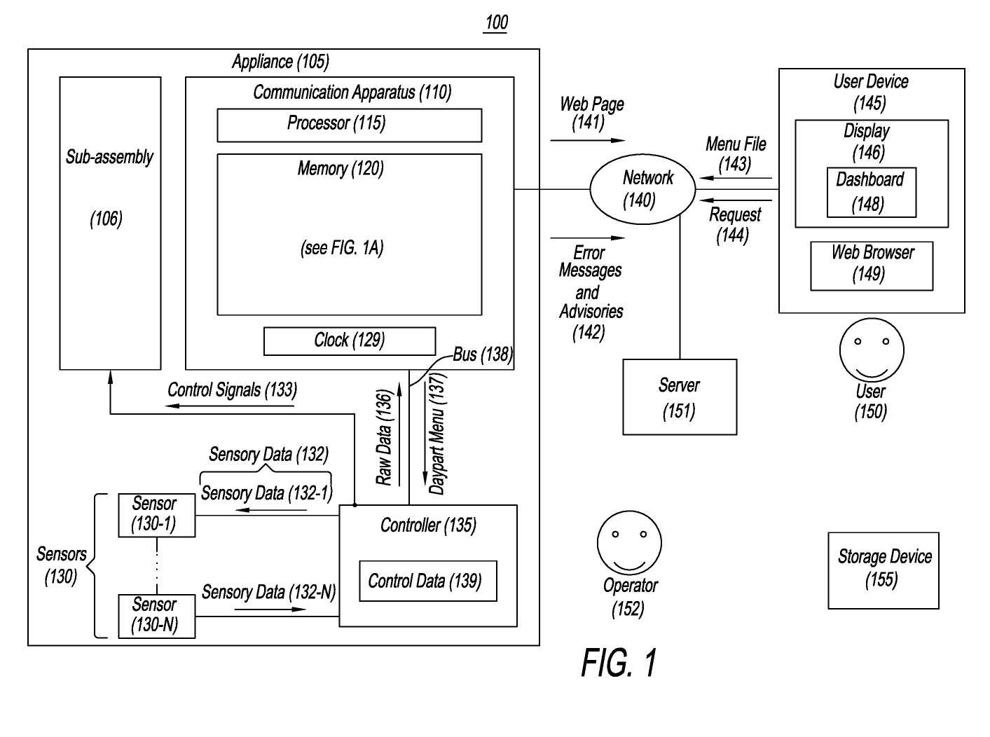

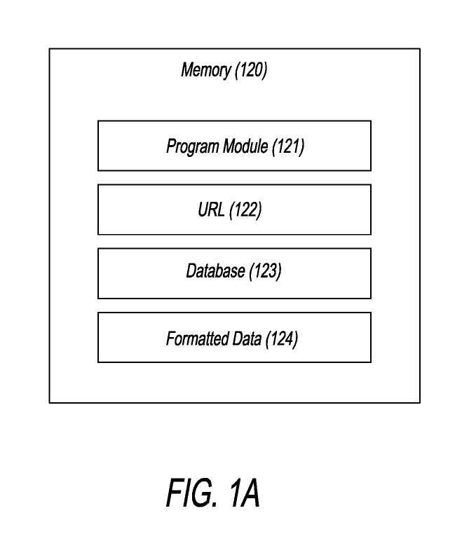

FIG. 1 is a block diagram of a system, i.e., system 100, for monitoring an operation of an appliance. System 100 includes an appliance 105 and a user device 145 that are communicatively coupled to a network 140.

Network 140 is a data communications network. Network 140 may be a private network or a public network, and may include any or all of (a) a personal area network, e.g., covering a room, (b) a local area network, e.g., covering a building, (c) a campus area network, e.g., covering a campus, (d) a metropolitan area network, e.g., covering a city, (e) a wide area network, e.g., covering an area that links across metropolitan, regional, or national boundaries, (f) the Internet, or (g) a telephone network. Communications are conducted via network 140 by way of electronic signals and optical signals that propagate through a wire or optical fiber, or are transmitted and received wirelessly.

Appliance 105 is a commercial kitchen appliance, e.g., a fryer, an oven, a conveyor oven, an ice machine, a beverage dispenser, a grill or other equipment or appliance, as would be used, for example, in a restaurant or a large-scale food production facility. Appliance 105 includes a sub-assembly 106, a plurality of sensors designated herein as sensors 130, a controller 135, and an intelligent data communication apparatus designated herein as communication apparatus 110.

Sub-assembly 106 is a collection of one or more electrical or mechanical components that provide for functional operation of appliance 105. For example, if appliance 105 is a fryer, sub-assembly 106 would include a vat and a heating element.

Sensors 130 sense conditions of appliance 105, and states of components within sub-assembly 106. Examples of sensors 130 include (a) a temperature sensor for sensing temperature, (b) a level sensor for sensing a level of a fluid, such as cooking oil or water, (c) a scale for measuring a weight of something, (d) a scale for measuring a quantity of something, (e) a gas sensor for sensing a presence of a gas, (f) a pressure sensor for sensing pressure, (g) an indicator of a state of a fluid control mechanism, and (h) a voltage sensor that, for example, senses a logic level voltage to determine a state of appliance 105 or a state of a component within appliance 105.

In practice, appliance 105 can include any number of one or more sensors 130, and in FIG. 1, two such sensors are represented and designated as sensors 130-1 and 130-N. Sensor 130-1 produces sensory data 132-1, and sensor 130-N produces sensory data 132-N. Sensory data 132-1 and sensory data 132-N are collectively referred to herein as sensory data 132. Sensory data 132 are voltages, electrical currents, or digital data streams that represent operating parameters of appliance 105 sensed by sensors 130, for example (a) a temperature, (b) a level of a fluid, (c) a weight of something, (d) a quantity of something, (e) a presence of a gas, (f) a pressure, (g) a state of a fluid control mechanism, or (h) a logic level voltage concerning a state of appliance 105 or a state of a component within appliance 105.

Controller 135 receives sensory data 132 from sensors 130, and provides raw data 136 to communication apparatus 110 on a bus 138. Controller 135 includes a processor (not shown) and a memory (not shown) that processes sensory data 132 to execute programmed routine tasks for controlling appliance 105 and more specifically, sub-assembly 106. Controller 135 includes a user interface (not shown) through which an operator 152 can set up controller 135 to control appliance 105. In response to inputs from operator 152, controller 135 establishes control data 139, which controller 135 sends to sub-assembly 106 in the form of control signals 133 to control sub-assembly 106. Raw data 136 is a combination of sensory data 132 and control data 139.

For example, sensory data 132-1 could be an analog signal that controller 135 would convert, by way of an analog-to-digital conversion, to a digital version of the analog signal. In this case, based on information obtained by controller 135 by interpretation of sensory data 132-1, controller 135 can prepare data that it would include in control data 139, and send to sub-assembly 106 by way of control signals 133, to actuate a component, e.g., an actuator or a switch, in sub-assembly 106.

Communication apparatus 110 includes a processor 115, a memory 120 coupled to processor 115, and a clock 129. Communication apparatus 110 monitors and analyzes raw data 136 from controller 135, and communicates with user device 145 via network 140.

The communications between communication apparatus 110 and user device 145 include (a) a web page 141 and error messages and advisories 142 that communication apparatus 110 sends to user device 145, and (b) a menu file 143 and a request 144 that user device 145 sends to communication apparatus 110.

Menu file 143 contains a recipe or product information to be programmed or re-programmed to controller 135 by communication apparatus 110 through bus 138.

Communication apparatus 110 sends to controller 135, via bus 138, a daypart menu 137. Daypart menu 137 reflects time-of-day based variations in product menus, such a breakfast, lunch, brunch, dinner, or late night, menus, or specials of the day for any of these dayparts.

Processor 115 is an electronic device configured of logic circuitry that responds to and executes instructions.

Memory 120 is a tangible, non-transitory, computer-readable storage device encoded with a computer program. In this regard, memory 120 stores data and instructions, i.e., program code, that are readable and executable by processor 115 for controlling operations of processor 115. Memory 120 may be implemented in a random access memory (RAM), a hard drive, a read only memory (ROM), or a combination thereof.

FIG. 1A is a block diagram of memory 120. Memory 120 provides storage for a program module 121, a uniform resource locator (URL) 122, a database 123, and formatted data 124. Program module 121 contains instructions for controlling processor 115 to execute operations described herein. In the present document, although we describe operations being performed by communication apparatus 110 or program module 121, the operations are actually being performed by processor 115.

The term “module” is used herein to denote a functional operation that may be embodied either as a stand-alone component or as an integrated configuration of a plurality of subordinate components. Thus, program module 121 may be implemented as a single module or as a plurality of modules that operate in cooperation with one another. Moreover, although program module 121 is described herein as being installed in memory 120, and therefore being implemented in software, it could be implemented in any of hardware (e.g., electronic circuitry), firmware, software, or a combination thereof.

URL 122 is a network address that identifies communication apparatus 110 so that communication apparatus 110 can be addressed and accessed by user device 145 via network 140.

Database 123 is a storage area for raw data 136 that communication apparatus 110 receives from controller 135, and interim processing data that communication apparatus 110 generates as it prepares formatted data 124, web page 141 and error messages and advisories 142.

Formatted data 124 is a result of execution of program module 121, and is included in web page 141, and presented on a dashboard 148 that is displayed on user device 145.

Refer again to FIG. 1.

Clock 129 maintains date and time for use by program 125.

Processor 115 outputs web page 141 and error messages and advisories 142 as a result of an execution of the operations described herein. Processor 115 can direct web page 141 and error messages and advisories 142 to user device 145 or to another remote device, e.g., a server 151, via network 140.

User device 145 is an apparatus that is operated by a user 150 and adapted for communication with communication apparatus 110 via network 140. Examples of user device 145 include a desktop computer, a portable computer, and a smart phone. User device 145 includes a display 146 and a web browser 149. Through operation of web browser 149, (a) user device 145 accesses communication apparatus 110 at URL 122, and (b) communication apparatus 110 presents, on display 146, a user interface designated herein as a dashboard 148. Dashboard 148 is a component of web page 141.

User 150 is a person, and may be, for example, a user or operator of appliance 105, or a person who is performing maintenance on appliance 105. User 150 may be at a location that is remote from appliance 105, or local to appliance 105, i.e., in close physical proximity to appliance 105.

While program module 121 is indicated as being already loaded into memory 120, it may be configured on a storage device 155 for subsequent loading into memory 120. Storage device 155 is a tangible, non-transitory, computer-readable storage device that stores program module 121 thereon. Examples of storage device 155 include (a) a compact disk, (b) a magnetic tape, (c) a read only memory, (d) an optical storage medium, (e) a hard drive, (f) a memory unit consisting of multiple parallel hard drives, (g) a universal serial bus (USB) flash drive, (h) a random access memory, or (i) an electronic storage device coupled to appliance 105 via network 140.

Although system 100 is shown as having only one appliance, i.e., appliance 105, and one user device, i.e., user device 145, in practice, system 100 may include any desired number of appliances and user devices.

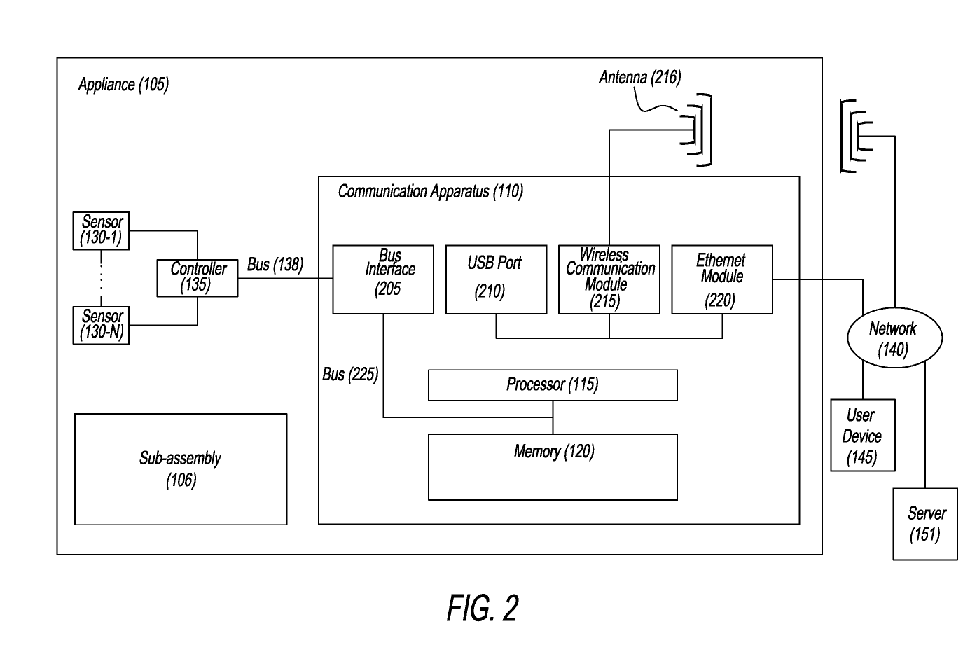

FIG. 2 is another block diagram of system 100, and shows some additional details of communication apparatus 110. Communication apparatus 110 includes a bus interface 205, a USB port 210, a wireless communication module 215, and an Ethernet module 220. Processor 115, memory 120, bus interface 205, USB port 210, wireless communication module 215, and Ethernet module 220 are communicatively coupled to one another through a bus 225. Bus interface 205 is also connected to bus 138. Thus, controller 135 and processor 115 communicate with one another through bus interface 205. Bus 138 and bus interface 205 can be implemented as part of a controller area network (CAN).

USB port 210 is a communications port to which user 150 may connect a USB-compatible device to communication apparatus 110 and thereby access data stored in memory 120. USB port 210 is adapted to mate with a USB cable. As such, if user device 145 is USB-compatible, user 150 could connect user device 145 to USB port 210 by way of a USB cable to access data, e.g., formatted data 124, from database 123.

Wireless communication module 215 is a network interface, and a communications port, that provides for wireless communication, e.g., Wi-Fi, between communication apparatus 110 and network 140. Wireless communication module 215 includes a radio frequency (RF) transceiver (not shown), and is coupled to an antenna 216. Communication apparatus 110 is addressable at URL 122 on network 140 through wireless communication module 215.

Ethernet module 220 is a network interface, and a hardwire communications port, that provides for hardwire communication between communication apparatus 110 and network 140. Communication apparatus 110 is addressable at URL 122 on network 140 through Ethernet module 220.

Processor 115 is configurable to conduct communications through network 140 by a path that includes either of wireless communication module 215 or Ethernet module 220.

Communication apparatus 110 is a communication system that stores, transmits, processes, and publishes data concerning appliance 105 to dashboard 148. Communication apparatus 110 provides access to data from appliance 105 both locally and remotely. In this regard, communication apparatus 110:
1) captures real time performance data, i.e., raw data 136, concerning appliance 105;
2) performs analytics on raw data 136 using heuristic techniques to evaluate critical performance parameters, and produces formatted data 124;
3) transmits formatted data 124 or dashboard 148 via Extensible Markup Language (XML) or JavaScript Object Notation (JSON) formats through a web browser, e.g., web browser 149, and publishes the data as organized webpages to one or more web accessible devices, e.g., user device 145;
4) transmits data via various methods, including USB, Ethernet, and Wi-Fi;
5) programs a menu file 143 in appliance 105 with daypart menus and recipes created by companion applications;
6) accepts communication device upgrades and configurations via dashboard 148 (through web browser 149) or USB port 210;
7) aggregates raw data 136, creates formatted data 124, and processes formatted data 124 to create and publish dashboard 148, thus providing information concerning appliance 105, such as energy usage, production efficiency (e.g., pounds of oil per pound of food prepared), performance efficiency (e.g., utilization of appliance 105), error logging and diagnostic data handling (e.g., recording of a state of appliance 105 for a period of time prior to the error), and standard operating procedure compliance (e.g., operational, cleaning), and allows the data to be aggregated and accessed for specified time periods;
8) captures a state of appliance 105 (e.g., component status (open, opening or closed), system status (heating, idling, cooking) and/or component functionality (working, working intermittently, not working)) for a period of time before an error has occurred, and provides malfunction and failure alerts to user device 145 via an email and/or a text message;
9) assists error and performance resolution by recording error data, and making actionable information available as error messages and advisories 142 to user 150 through dashboard 148 and/or USB port 210;
10) provides information to optimally perform condition-based equipment maintenance (replacing consumables, cleaning, and preventative maintenance), management of energy (gas/electric), and production management (food and food preparation components).

In operation, communication apparatus 110 receives, from controller 135, raw data 136 that represents an operating parameter of appliance 105. User device 145 sends, and communication apparatus 110 receives, a request 144 for a report. Communication apparatus 110 converts raw data 136 into formatted data 124, incorporates formatted data 124 into a report in the form of web page 141, i.e., dashboard 148, for display on user device 145, and sends web page 141, i.e., dashboard 148, to user device 145. More specifically, since user device 145 has web browser 149 installed therein, communication apparatus 110 prepares dashboard 148 for presentation on display 146 via web browser 149. Thus, communication apparatus 110 employs local intelligence to analyze raw data 136 and prepare formatted data 124 and web page 141, and user device 145 does not need any special-purpose software to analyze raw data 136 or to view formatted data 124.

Communication apparatus 110 captures appliance 105's performance and efficiencies individually, providing user-readable data, i.e., formatted data 124 that encompass both food preparation capacity and efficiency. This efficiency can be defined by all resources that are spent during operation of appliance 105, including food processing operations. In a case of multiple appliances, continuous tracking and analysis of each appliance allows for accurate assessment of both appliance and restaurant-wide resources, to assist in identifying where points of improvement can be determined.

Communication apparatus 110 also provides diagnostic data to user 150, e.g., a maintenance person, by monitoring appliance state information, and in a case of an error or malfunction, automatically places a call for maintenance, for example by way of an email, a forwarded phone message or a text message, e.g., error messages and advisories 142. Additionally, communication apparatus 110 can include information about the error or malfunction on dashboard 148.

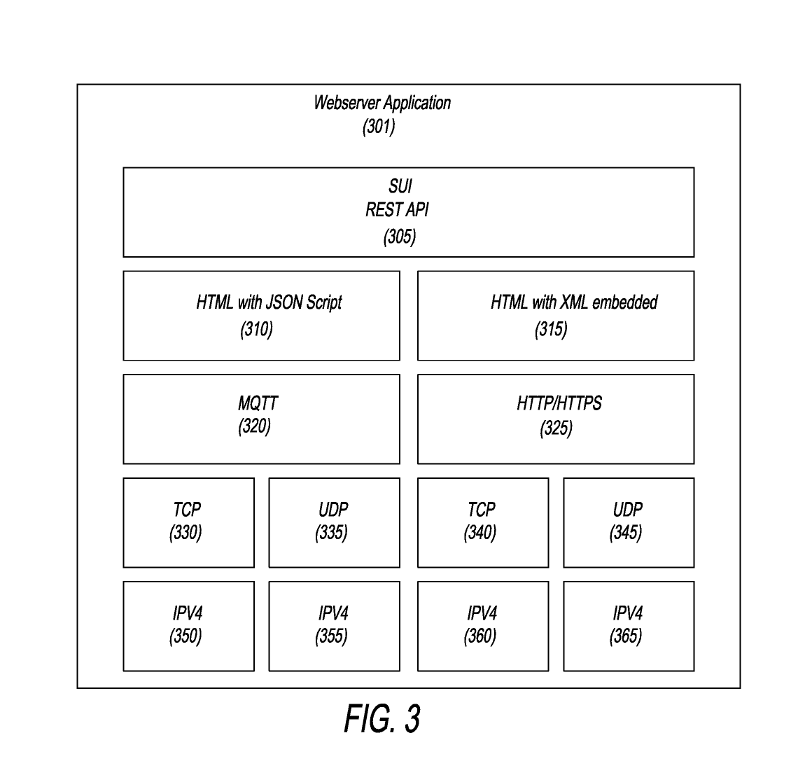

FIG. 3 is a block diagram of a webserver application 301 that is a component of program module 121. Webserver application 301 produces dashboard 148, and includes the following stack of software layers:

### (a) SUI REST API 305;

(b) HTML with JSON Script 310;
(c) HTML with XML embedded 315;

### (d) MQTT 320;

### (e) HTTP/HTTPS 325;

### (f) TCP 330;

### (g) UDP 335;

### (h) TCP 340;

### (i) UDP 345;

### (j) IPV4 350;

### (k) IPV4 355;

### (l) IPV4 360; and

### (m) IPV4 365,

where:

SUI=System User Interface

REST API=Representation State Transfer Application Programming Interface

HTML=HyperText Markup Language

JSON=JavaScript Object Notation

XML=Extensible Markup Language

MQTT=MQ Telemetry Transport

TCP=Transmission Control Protocol

UDP=User Data Gram

HTTP=Hypertext Transfer Protocol

HTTPS=Secure HTTP

IPV4=Internet Protocol Version 4

The layers of webserver application 301 use open protocols that enable easy information exchange with the outside world.

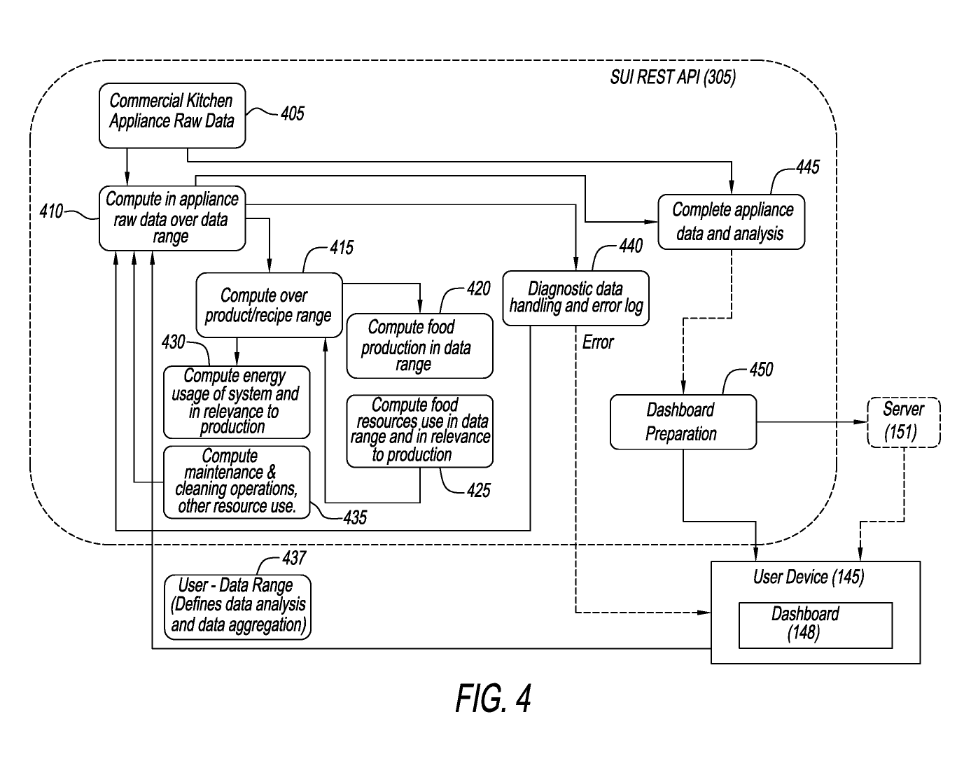

FIG. 4 is a block diagram of operations performed by SUI REST API 305. Arrows in FIG. 4 do not necessarily represent sequences of operations, but data flow.

In sub-process 405, SUI REST API 305 receives raw data 136. Raw data 136 represents operating parameters of appliance 105 that have been sensed by sensors 130 and routed via controller 135, through bus 138, to bus interface 205.

In a data packet 437 from user device 145, SUI REST API 305 receives user data, and more specifically, a data range that is used for data analysis and data aggregation. User 150 enters data for data packet 437 via dashboard 148, and data packet 437 can be included as part of request 144.

In sub-process 410, SUI REST API 305 processes raw data 136 from sub-process 405 over the data range specified in data packet 437.

In sub-process 415, SUI REST API 305 computes appliance production over a product/recipe range that is contained within raw data 136.

In sub-process 420, SUI REST API 305 computes food production in a data range defined in data packet 437.

In sub-process 425, SUI REST API 305 computes food resource use in a data range defined in data packet 437 in relevance to production.

In sub-process 430, SUI REST API 305 computes energy usage of appliance 105, and in relevance to production.

In sub-process 435, SUI REST API 305 computes maintenance and cleaning operations, and other resource use.

In sub-process 440, SUI REST API 305 performs diagnostic data handling and error logging. The diagnostic data and error are reported to user device 145, as error messages and advisories 142.

In sub-process 445, SUI REST API 305 processes raw data 136, by utilizing the computed information from sub-process 410, thus the results of sub-processes 415, 420, 425, 430, 435, to update previously obtained results on data for all available data ranges, including what is provided by sub-process 437, and completes appliance data analysis.

In sub-process 450, SUI REST API 305 prepares information, e.g., formatted data 124, for dashboard 148, and sends the information to user device 145 in web page 141. SUI REST API 305 also sends the information to server 151, from which the information can be accessed by user device 145 and other devices (not shown) over the Internet, subject to user authentication. Server 151 publishes at least one dashboard 148 from at least one appliance, e.g., appliance 105, and possibly a multiplicity of dashboards 148 from a multiplicity of appliances.

Regardless of whether user device 145 receives information from communication apparatus 110 by way of sub-process 440, sub-process 450, or from server 151, user device 145 will obtain the information via web browser 149. As such, user device 145 does not need to have a special-purpose application installed therein, but instead, can be any device that includes and operates with a general-purpose Internet browser.

Communication apparatus 110 converts raw data 136 into information and knowledge using IT principles/technologies such as HTML, JSON, XML, and more generally, the Internet of things (IoT), to serve content locally, and remotely. IoT is the internetworking of physical devices, vehicles (also referred to as “connected devices” and “smart devices”), buildings and other items, embedded with electronics, software, sensors, actuators, and network connectivity that enable these objects to collect and exchange data.

Raw data 136 is data that comes from the controller 135 without having yet been processed into information or knowledge. For example, the temperature of a vat in appliance 105, by itself, does not provide user 150 with much insight into whether appliance 105 is operating properly, but when combined with product cooked and RTD (Resistance Temp. Detector) condition (open, shorted, etc.) the temperature will be indicative as to whether something is wrong.

The information and knowledge provided by communication apparatus 110 may lead user 150 to perform some action to improve the operation of appliance 105. For example, if a filter bypassed count (described below) is large, then that information combined with other information about last serviced, oil quality can prompt user 150 to notify a manager that operators of appliance 105 are not following proper procedures. By taking corrective action, for example requiring the operators to follow the proper procedures, the manager can improve the operation, efficiency or energy utilization of appliance 105.

Production information, in other words, food processing or food production information, is obtained by aggregating and analyzing raw data 136 on operations regarding food processing within a user-specified time period provided in data packet 437, and overall commission time of appliance 105 and communication apparatus 110, as in sub-process 445 (in case of retrofit starting from an establishment of connectivity between communication apparatus 110 and appliance 105).

Production information of appliance 105 can be directly calculated from food processing operation data available in raw data 136.

### Total Production:

Total Production is calculated for food production done within analysis time frame defined by user 150 in data packet 437.

$$Total production = {\sum }_{i = Start Date}^{End Date} {\sum }_{j = Product 1}^{Product n} Production {event}_{ij}$$

Production Event Per Product:

Production event per product is calculated for processing each product/recipe done.

$$Production event per {product}_{i} = {\sum }_{j = Start Date}^{End Date} Production {event}_{{j}_{i}} , i = 1 , 2 … n th product$$

Average Production Per Day:

Average production per day is calculated for number of production events within analysis range, and calculates average production done per day. This method is also applied to each product to determine average processing of each product per day, where number of days is calculated as a close range (start and end date included) from user provided analysis time range from data packet 437.

$$Average production per day = \frac{Total production}{No . of days in selected period}$$

Where, no. of days in selected time period is:

$$No . of days in selected period \text{:} End Date - Start Date + 1$$

$$Average production event per product per {day}_{i} = \frac{Production event per {product}_{i}}{No . of days in selected period} , i = 1 , 2 , … n th$$

In the case of calculation of production done by appliance 105, where production is not directly measured by handling of product or recipes in appliance 105, raw data 136 for components or systems, i.e. sub-assembly 106, responsible for appliance production are analyzed to compute appliance production. An instance of this is when appliance 105 processes a food commodity, or physical handling of food ingredients, such as a product dispenser or an ice maker.

Production system activity is measured in number of operations or production activity duration and following calculations are made:

$$Total production = {\sum }_{i = Start Date}^{End Date} {\sum }_{j = Product 1}^{Product n} {N}_{ij} {R}_{ij}$$

Where; R is a denotation for a specific volume of production for each product per operation or production activity.

Average Production:

$$Average production = \frac{Total production}{No . of days in selected time period}$$

Production Per Cleaning and Maintenance Activity

In addition to production information that portrays production performance and variety of products in appliance 105, communication apparatus 110 also analyzes raw data 136 for number of production events per routine operational activities that has to take place in a commercial food processing operation, such as appliance cleaning and maintenance, renewal of equipment resources as needed based on usage (either food processing count or days of operation). These activities are denoted as C&M activities.

Appliance data acquisitioned, i.e. raw data 136, is analyzed within user specified time range and for equipment life time.

$$Production per C \& M Activity = \frac{Total production}{Total No . of C \& M Activity}$$

Equipment cleaning and maintenance operations and consumption of equipment level resources are also analyzed.

Cleaning and Maintenance Activity Per Day:

Cleaning and maintenance activity per day is calculated by using data gathered for cleaning and maintenance activities within analysis time frame.

$$C \& M Activity per day = \frac{Total Cleaning and maintenance activities}{No . of days in selected time period}$$

Cleaning and Maintenance Activity Bypass:

Cleaning and maintenance activity bypass is calculated within the time frame given by user for the analysis as follows:

$$C \& M Activity Bypassed = \frac{Σ C \& M Activity bypassed}{No . of days in selected time period}$$

Cleaning and maintenance activities that comprise of replacement of a consumable appliance resource are analyzed over analysis time frame and on a daily average.

Total Consumable Equipment Resource Used:

$$Total Equipment Consumable Resource = {\sum }_{Start Date}^{End Date} Equipment Consumable Resource used$$

$$Total consumable equipment resource per day = \frac{Total Equipment Consumable Resource}{No . of days in selected time period}$$

Appliance energy usage is analyzed by communication apparatus 110 as indicated below.

Total Appliance ON Time:

Total Appliance ON Time is calculated for the duration appliance 105 is on, in other words powered,

$$Total appliance ON time = {\sum }_{Start Date}^{End Date} Appliance ON duration$$

Average Appliance ON Time:

Average Appliance ON Time is calculated as appliance on time per day based on total appliance ON time over the number of days within analysis time period.

$$Average appliance ON time = \frac{Total appliance ON time}{No . of days in selected time period}$$

Total Appliance Work Time:

Total Appliance Work Time is calculated for the duration of work being done by primary appliance system, in sub-assembly 106, that is defined by execution of the primary function of appliance 105. The primary function of an appliance is defined as the execution of certain tasks and operations that result in production, preparation or conditioning of food or food resources and commodities, for instance; heating systems, cooling systems or components, force or torque exertion components. It is calculated within a time period defined by user 150 in data packet 437.

Total Appliance Work Time=Σ_{StartDate}^{EndDate}Appliance Work Time

Average Appliance Work Time:

Average Appliance Work Time is calculated for total appliance work time per day observed during analysis time period. Raw data 136 are analyzed by communication apparatus 110 between a “from date” and a “to date” given by user 150 in data packet 437, and total appliance work duration is divided by number of days within time period for the analysis.

$$Average appliance work time = \frac{Total appliance work time}{No . of days in selected time period}$$

Total Appliance Idle Time

Idle stage is defined as the state where appliance 105 is not conducting in activities that consist of primary function or cleaning and maintenance activities. Communication apparatus 110 tracks and analyzes raw data 136 to calculate duration of idle time throughout the analysis time period.

Total appliance idle time=Σ_{StartDate}^{EndDate}Appliance idle duration

Average Appliance Idle Time:

Average Appliance Idle time is calculated by dividing total appliance idle time by number of days within selected time period.

$$Average appliance idle time = \frac{Total appliance idle time}{No . of days in selected time period}$$

Analysis of food resources, commodities and utilities are done within the time period defined by the user and for appliance life time. The techniques employed herein incorporate parameters related to total and average production within a user-defined analysis time period or time periods defining regulatory or operational removal, or replenishment of food resources, commodities or utilities. Communication apparatus 110 appliance configurations determine correct constants and calculation methods to be used. Communication apparatus 110 analyzes use of food resources, food commodities and utilities, by analyzing raw data 136 that contains messages regarding states of sensors 130-1 to 130-N, triggered by I/O for each component that contributes to sensors 130, separately or combined monitoring respective food resources, food commodities and utilities in events of removal or addition. Communication apparatus 110 processes this information in defining time periods for these events, and in comparison to production parameters to calculate efficiencies in use of food resources, food commodities and utilities.

FRCU=Food Resources,Food Commodities, and/or Utility

All food resources, food commodities and utilities, if multiple exist, are calculated separately. In addition communication apparatus 110 computes food resources, food commodities and utilities in two distinctive ways, depending on appliance 105 configuration, resource, utility or commodity type, I/O information regarding sensors 130, that are transmitted to communication apparatus 110 as raw data 136 through bus 138.

1. Constant Addition or Removal Per Unit Time

$$FRCU {usage}_{i} = {\sum }_{j = Start Date}^{End Date} {C}_{i} {T}_{{event}_{ji}} , i = 1 , 2 , … n th resource$$

Where:

C₁=Amount of FRCU added or removed per unit time

Tₑᵥₑₙₜ_{ᵢ}=Duration of FRCU addition or removal time

Average FRCU Usage Per Day:

$$Average FRCU {usage}_{i} = \frac{FRCU {usage}_{i}}{No . of days in selected time period} , i = 1 , 2 , … n th resource .$$

Relation to Production is Established by Following:

Production Per FRCU:

This is calculated per resource commodity and utility available to appliance 105.

$$Production per {FRCU}_{i} = \frac{Total production}{FRCU {usage}_{i}} , i = 1 , 2 , … n th FRCU$$

2. Constant Addition or Removal of FRCU with Each Event

$$FRCU {usage}_{i} = {\sum }_{j = Start Date}^{End Date} {C}_{i} {T}_{{event}_{ji}} , i = 1 , 2 … n th resource . \\ {N}_{{event}_{i}} = Number of FRCU addition or removal event$$

In this calculation, time and production between food resource, food commodity and utilities are further analyzed.

Days Per Event:

Days Per Event describes what resource usage is recorded by appliance 105 and conveyed to communication apparatus 110 through raw data 136.

Days per event=Last event in analysis time period−Prior Event Detected+1

An average is calculated for appliance 105 where there are individual sub-systems or vessels, such as sub-assembly 106, which independently utilize food resources, food commodities or utilities.

$$Average days per event = \frac{{\sum }_{i = Subsystem 1}^{Sub system N} Days per {event}_{i}}{N}$$

Production Per Event:

Production per event is calculated by a division to production index calculated for an analysis time period that is provided in data packet 437.

$$Production per event = \frac{{\sum }_{i = Subsystem 1}^{Sub system N} {Production}_{i}}{N}$$

Communication Apparatus Deep Fat Fryer Application

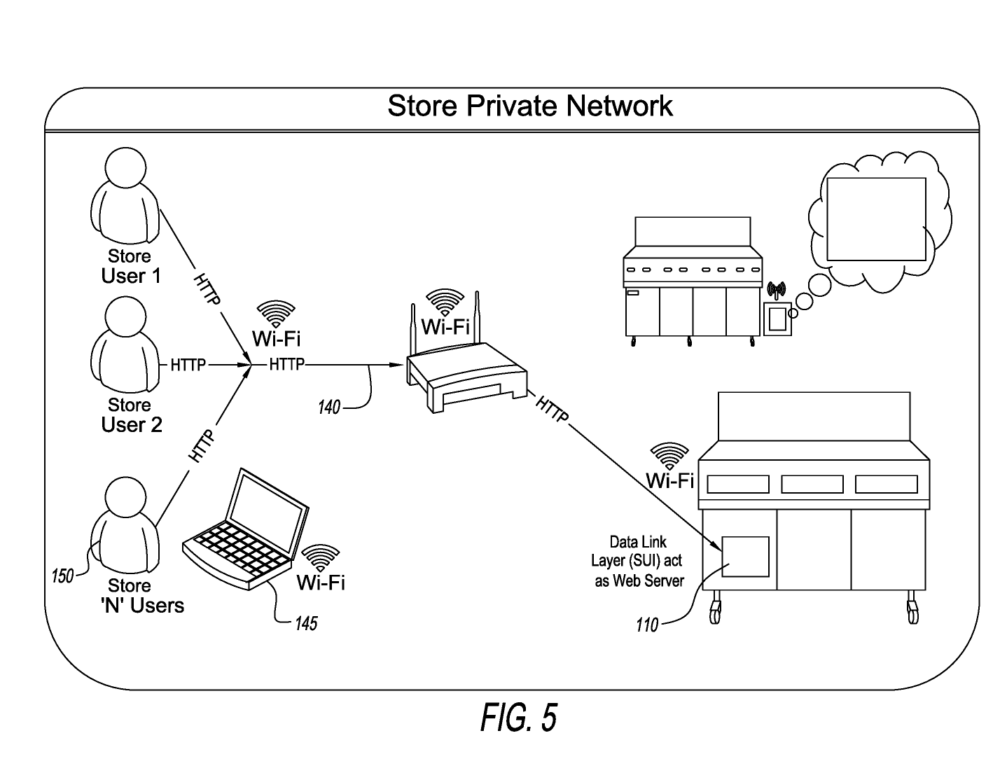

FIG. 5 is an illustration of communication apparatus 110 being employed in a deep fat fryer, in a system designated as system 500.

In system 500, user 150 is one of plurality of users, network 140 is implemented as a Wi-Fi network, and communication apparatus 110 provides, for example, the following information:

(a) Food production;

(b) Filter and cleaning;

(c) Energy use;

(d) Oil (usage and life);

(e) Fryer performance; and

(f) Oil Total Polar Material (TPM) readings or other by-product or soiling metrics.

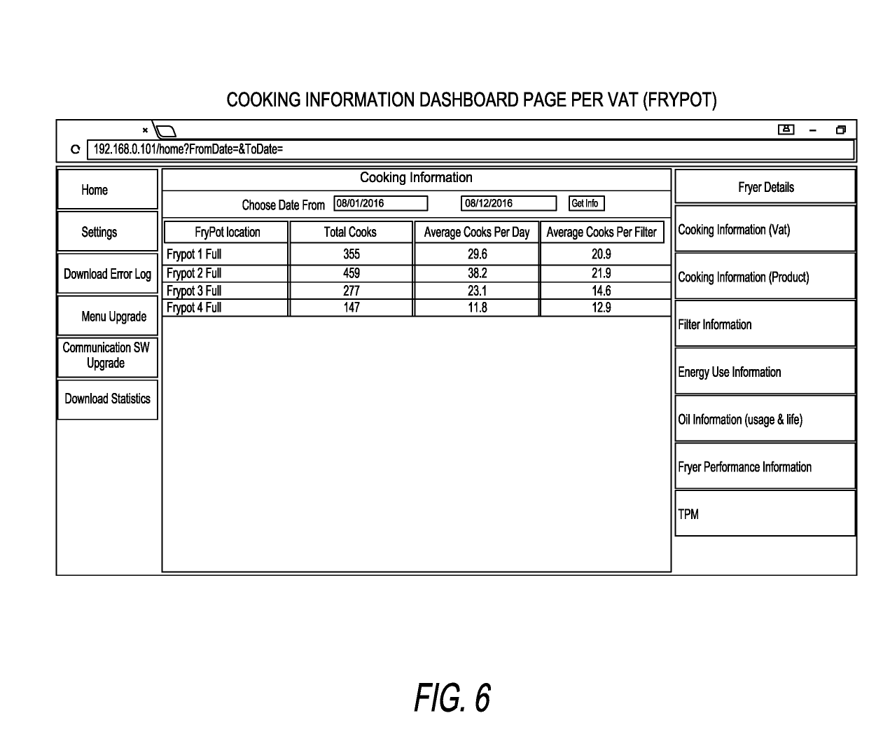

FIG. 6 is a screen shot of dashboard 148, showing cooking information per vat in a frypot. The cooking information by vat (frypot) dashboard page displays the following per vat (frypot):

(i) Total cooks for selected time period;

(ii) Average cooks per day for the selected time period; and

(iii) Average cooks per filter for the selected time period.

Total Cooks Per Time Period

When communication apparatus 110 receives raw data 136 that is based on sensory data 132 from a particular vat (frypot), a COOK START event triggers SUI REST API 305 and increments a cooks started counter that is stored in database 132. The total cooks parameter is calculated based on the state of the fryer (cook start and cook done) and a running total is kept by SUI REST API 305, specifically sub-process 445.

Average Cooks Per Day:

Average Cooks per Day is calculated by dividing the number of cooks completed during the selected number of days by the selected number of days.

$$Average Cooks Per Day = \frac{{\sum }_{i = from date}^{to date} total cooks completed}{No . of days between selected period}$$

Average Cooks Per Filter:

Average Cooks per Filter is calculated by dividing the number of cooks completed during the selected number of days by the number of filtrations completed during the selected number of days.

$$Average Cooks Per Filter = {\sum }_{i = from date}^{to date} ( \frac{total cooks completed}{No . of filters completed} )$$

The type of product cooked and the quantity of the product cooked data provides insight into what is selling most during a time period and allows comparison with Point-of-sale (POS) data.

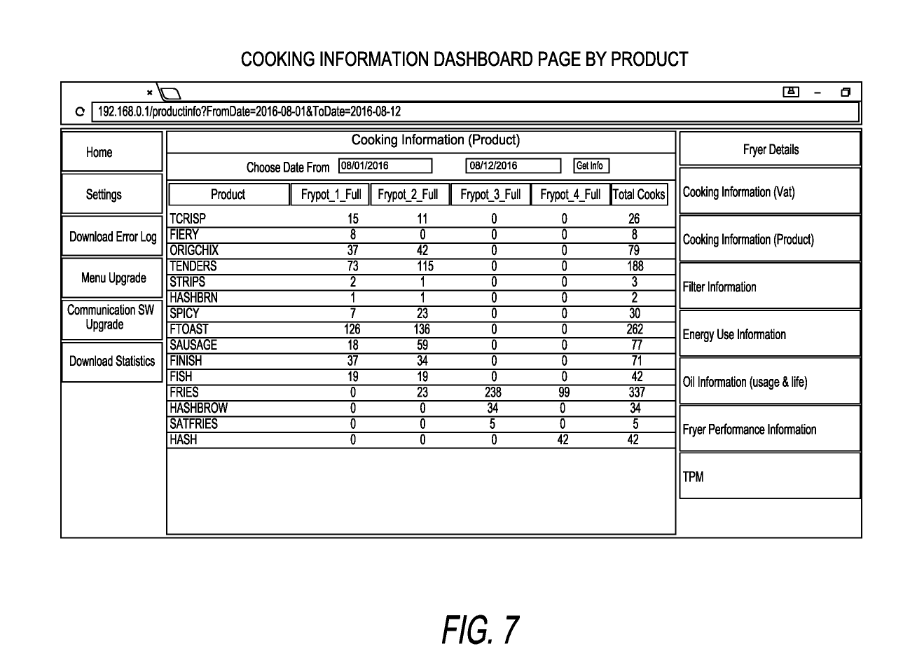

FIG. 7 is a screen shot of dashboard 148, showing cooking information by product. The cooking information by product dashboard page shows each type of product cooked during the selected time period and the quantity cooked for that time period per vat (frypot).

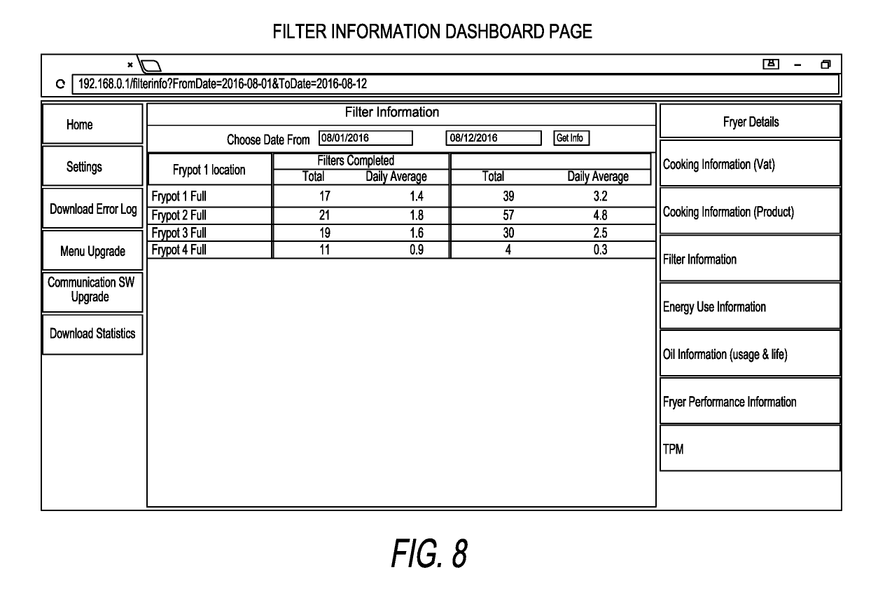

FIG. 8 is a screen shot of dashboard 148, showing filter information. The filter information dashboard page shows the number of filtrations done and by-passed along with averages, during the selected time period per vat (frypot):

(i) Filters completed: total and average per day; and
(ii) Filters by-passed: total and average per day.

When communication apparatus 110 receives raw data 136 that comprises a first message that includes a dataset of filter type (auto, maintenance, and polish), vat (frypot) type (full, split), filter status (busy), and vat ID, and a second message that indicates that filtration is done, the filter completed event triggers SUI REST API 305, which then increments a corresponding vat (frypot) filtration counter.

Filters Completed (Daily Average):

Filters Completed (Daily Average) is calculated by dividing the number of filtrations completed during the selected number of days by the number of days.

$$Filter Completed ( daily Average ) = \frac{{\sum }_{i = from date}^{to date} total filtrations completed}{No . of days between selected period}$$

Filter Bypassed (Daily Average):

Filter Bypassed (Daily Average) is calculated by dividing the number of filtrations cancelled during the selected number of days divided by the number of days.

$$Filter Bypassed ( daily Average ) = \frac{{\sum }_{i = from date}^{to date} total filtrations cancelled}{No . of days between selected period}$$

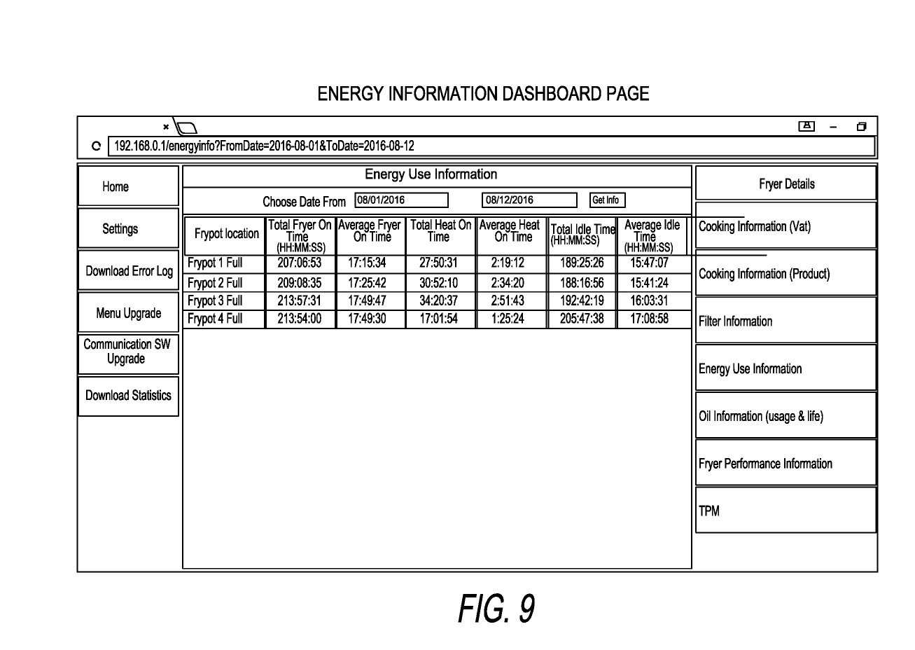

FIG. 9 is a screen shot of dashboard 148, showing energy information. The energy information dashboard page displays the following per vat (frypot):

(i) Total Fryer On time;

(ii) Total Heat On time;

(iii) Total Idle time;

(iv) Average Fryer On time;

(v) Average Heat On time; and

(vi) Average Idle time.

When communication apparatus 110 receives raw data 136 for each of the above mentioned energy information events, SUI REST API 305 increments the corresponding vat (frypot) energy counter.

Total Fryer ON Time:

Total Fryer ON Time is the total time at least one vat, if there is a plurality of vats (frypots), is powered on during a 24-hour period. The vat may be in a state of active cooking, idling, filtering or conducting different activities during this time period.

When a vat is switched between OFF to ON state, information concerning the change of vat between these states is provided with a message in raw data 136 that is received by communication apparatus 110 and then analyzed by SUI REST API 305 to calculate Total Fryer ON Time.

Average Fryer ON Time:

Average Fryer ON Time is calculated by dividing the time duration of VAT_ON time divided by selected number of days.

$$Average fryer ON time = \frac{{\sum }_{i = from date}^{to date} fryer ON duration}{No . of days between selected period}$$

Total Heat ON Time:

Messages associated with Vat Heat ON Time and Vat Heat OFF Time are comprised of:

(i) first data that indicates the IO type; and

(ii) second data that indicates a status of the particular vat.

When communication apparatus 110 receives the above messages in raw data 136, SUI REST API 305 will calculate, by processing the status, a Heat ON Time.

Average Heat ON Time:

Average Heat ON Time is calculated by dividing the time duration of the Heat ON time by the selected number of days.

$$Average heat ON time = \frac{{\sum }_{i = from date}^{to date} heat ON duration}{No . of days between selected period}$$

Total IDLE Time:

The formula below is used to calculate total idle time of a particular vat.

$$total idle time = {\sum }_{i = from date}^{to date} ( Total Vat ON time - ( Total Cook Time + Total Filter Time ) )$$

Average IDLE Time:

Average IDLE Time is calculated by dividing the time duration of the Total Idle time by the selected number of days.

$$average idle time = \frac{total idle time}{No . of days between selected period}$$

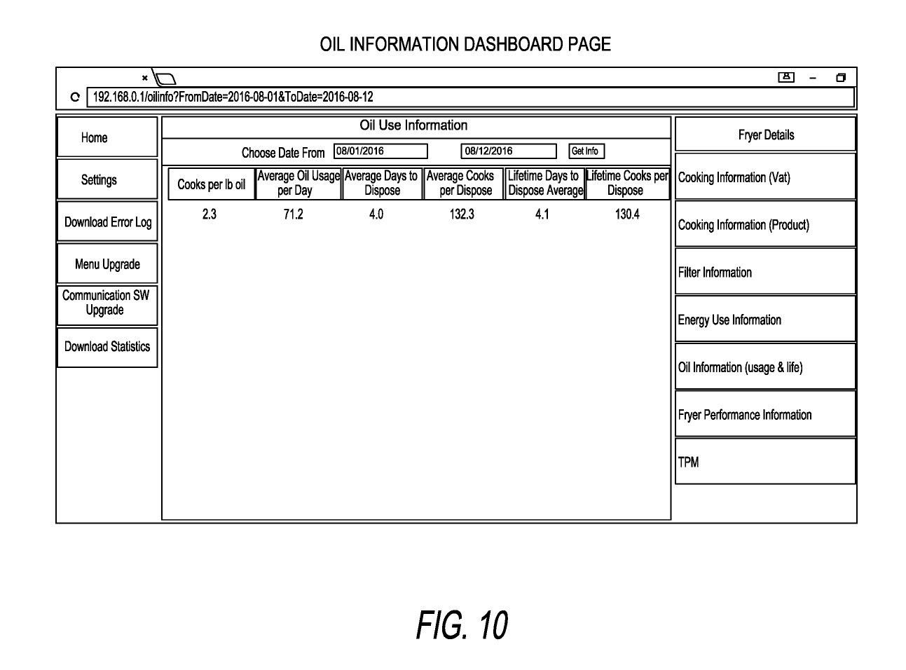

FIG. 10 is a screen shot of dashboard 148, showing oil information. The oil information Dashboard page displays the following:

(i) The number of cooks per lb. of oil;

(ii) Average oil usage per day;

(iii) Average days to dispose;

(iv) Average cooks per dispose;

(v) Lifetime days to dispose average; and

(vi) Lifetime cooks per dispose.

Cooks Per Pound of Oil:

This is the number of cooks done per unit amount (lbs.) of top-off oil used within the selected period. Cooks Per Pound of Oil is calculated by processing the information on cooks done on all vats (vat level events) and the number of JIB (Jug in a Box, a volume of oil reservoir) resets (system-level events) within the selected period, where a JIB reset is defined as replacement of the said constant volume oil reservoir.

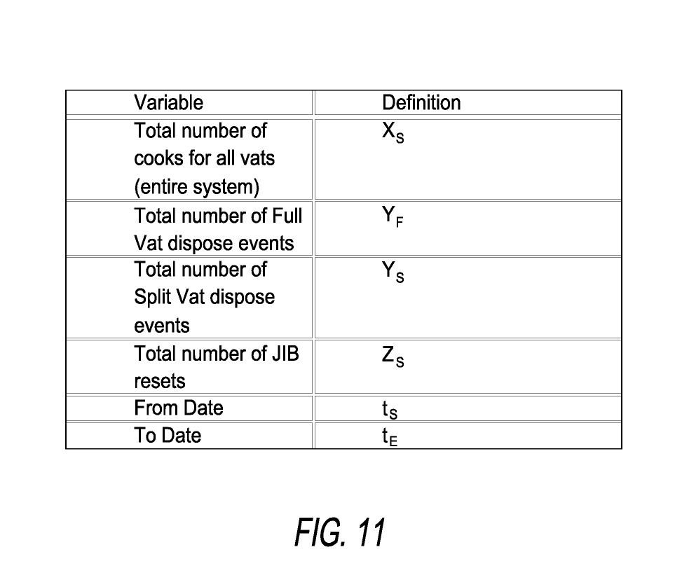

FIG. 11 is a table, namely TABLE 1, of variables for an example of a calculation of cooks per lb. of oil. Per denotations defined in TABLE 1, cooks per lb. of oil can be calculated as follows:

$$Cooks Per Lb Oil ( \frac{1}{Lbs .} Oil ) = \frac{{X}_{s}}{{V}_{JIB} {Z}_{s}}$$

Where;

V_{JIB}: JIB volume (Lbs.)

This calculation processes raw data 136 as follows:
1. Read user input: from and to date.
2. Compute Xₛ, total number of cooks for appliance 105 between the analysis time frame (from—to date). In other words, loop over days and vats in the data to accumulate total number of cooks for appliance 105 between from and to date:

$${X}_{s} = {\sum }_{i = From Date}^{To Date} {\sum }_{j = Vat 1}^{N th Vat} {Cooks}_{ij}$$

3. Compute total JIB resets, accumulate JIB resets to find total number of JIB resets between to and from date:

$${Z}_{s} = {\sum }_{i = From Date}^{To Date} JIB Resets$$

4. Determine V_{JIB}, JIB volume may differ between platforms (different fryer models use varying volume of top-off oil reservoirs).
   Assumption: Every JIB reset results in full replacement of top-off oil reservoir. (No partial filling of JIB, or replacement with a JIB, that is not completely full)
   Assumption: Only fresh oil source is considered as JIB. Cooks per lb. of oil parameters shows the number of cooks done per amount of JIB oil (lb.) used.
5. Calculate cooks per lb. of oil as formula given above.

Average Oil Usage Per Day:

Average Oil Usage Per Day is calculated by using the total oil usage for the requested period and the number of days of the requested period. Total oil usage is comprised of the total number of dispose events (full and split vats separately) and the total number of JIB resets.

Average Oil Usage Per Day utilizes JIB reset and dispose event information to calculate the average daily oil usage for the requested period (to and from date).

Where;

Y_{F}: Number of times a full vat's oil is disposed between from and to date.

Yₛ: Number of times a split vat's oil is disposed between from and to date.

Zₛ: Total number of JIB resets between from and to date.

t_{E}−tₛ+1: Number of days between from and to date. (From and to date included).

The method is as follows:

1. Loop over days and vats on data within from and to date.

2. Accumulate Full Vat dispose event count.

3. Accumulate Split Vat dispose event count.

Steps 2 and 3:

$${Y}_{F} = {\sum }_{i = From Date}^{To Date} {\sum }_{j = Full vat 1}^{N th Full Vat} {Dispose}_{ij}$$

$${Y}_{S} = {\sum }_{i = From Date}^{To Date} {\sum }_{j = Split vat 1}^{N th Split Vat} {Dispose}_{ij}$$

4. Compute average oil usage per day:

$$Avg Oil Usage per day = \frac{30 \times {Y}_{F} + 15 \times {Y}_{s} + {V}_{JIB} \times {Z}_{F}}{{t}_{E} - {t}_{s} + 1}$$

Assumption: An Oil Disposal Event is Followed by a Refill Event

Average Days-To-Dispose:

Average Days-To-Dispose is the average duration (number of days) between two dispose events for all vats. The individual vat days-to-dispose metric is calculated between the last dispose that is dated inside the analysis time frame and one prior dispose (not constrained by the start date for the analysis) for each vat. Days-To-Dispose is calculated taking the average of all vats.

Average Days-To-Dispose utilizes data available per vat if both a last and prior dispose event date is available.

If a latest dispose date is available, the dispose date closest to the end of the requested period is used, but if no dispose event date can be found prior to two weeks from the To Date (end of the requested period), data for the respective vat is not used. Therefore the number of vats used in the calculation decreases by 1.

If a case occurs where days to dispose is not available for any vat, in other words no vat has dates for two dispose dates where days in between can be counted, the average days to dispose is not calculated and user is notified with the information that there is no suitable data to calculate days to dispose.

1. Loop over data per day (Start: From Date-End: To Date)

2. Loop over daily data per vat

3. Find latest dispose event per vat
(i) If no dispose data exists within time period exclude vat from analysis.
(ii) nᵥₐₜₛ−=1, Reduce total number of vats by one.
(iii) If there is no prior dispose data, exclude vat from analysis.
(iv) nᵥₐₜₛ−=1, Reduce total number of vats by one.

4. D₂=Latest Dispose Event Date per vat

5. Find prior dispose date per vat, D₁=Prior Dispose Event Per Vat.

6. Compute Days-To-Dispose per vat, D₂−D₁ per vat.

7. Accumulate daily cook counts per vat from D1 to D2.

8. Take average of days-to-dispose per vat to obtain average days-to-dispose:

$$Avg Days \text{-} To \text{-} Dispose = \frac{Σ Days \text{-} To \text{-} {Dispose}_{i}}{{n}_{vats}}$$

Cooks Per Dispose:

Cooks Per Dispose is the average number of cooks per dispose for all vats. It is calculated between the latest dispose event in the selected period and the prior dispose (if available) event found up to two weeks prior from the last dispose date assigned per vat.

Accumulation of the cook counts per vat is done for the days in between D2, latest disposal date, and D1, one prior dispose date, defined in the algorithm for days-to-dispose calculations.

Rules for the calculation of the dispose dates and number of the vats to be taken into account to calculate system level average parameter apply also to the calculation of cooks per dispose.

Average cooks done between two dispose events for the system calculated by averaging cooks per dispose for each vat.

Steps 1-7 are the same as the calculation for Average Days-To-Dispose

8. Average cooks per dispose for each vat to compute average cooks per dispose:

$$Avg Cook per Dispose = \frac{Σ Cooks per {dispose}_{i}}{{n}_{vats}}$$

Lifetime Days-To-Dispose:

Lifetime Days-To-Dispose is a running average of the system level average of days-to-dispose. This parameter is an average of lifetime days-to-dispose average per vat. Average days-to-dispose per vat is calculated by dividing the number of days passed between two disposes from the last to first dispose date by number of disposes. Then information for each vat is used to get the global lifetime days to dispose. This information is constantly updated and each new dispose will contribute to the number.

Lifetime Days-To-Dispose is a running average where every available days-to-dispose data per each vat is used to update lifetime days-to-dispose average. Lifetime Days-To-Dispose can be calculated if at least one of the vats in the system has 2 or more dispose events recorded.

1. Calculate Lifetime Days to Dispose Average for Each Vat that has 2 or More Dispose Events.

Number of vats, lifetime days-to-dispose average per vat available is denoted as, nᵥₐₜₛ.

$$Average Days \text{-} To \text{-} Dispose Per Vat = \frac{{\sum }_{i = 2}^{N} ( Dispose {Date}_{i} - Dispose {Date}_{i - 1} )}{N - 1}$$

2. Calculate Lifetime Days-To-Dispose:

$$Lifetime Days \text{-} To \text{-} Dispose = \frac{Σ Average Days \text{-} To \text{-} Dispose Per Vat}{{n}_{vats}}$$

Lifetime Cooks Per Dispose:

Similar to lifetime days-to-dispose, cooks per dispose per vat is averaged from latest to earliest data available. Vat data is averaged to acquire lifetime cooks per dispose information for the all system.

A running average of cooks per dispose per vat is kept. This information is constantly updated with new dispose event entries. Lifetime cooks per dispose per vat is calculated using the total cooks and days-to-dispose information. For the system level lifetime cooks per dispose average of lifetime cooks per dispose average per vat is taken.

The lifetime cooks per dispose parameter can be calculated if at least one of the vats in the system has 2 or more dispose events recorded.

$$Cooks per dispose per vat = \frac{{\sum }_{Date of 1 st dispose}^{Date of Nth dispose} Cooks}{N - 1}$$

Again, let nᵥₐₜₛ be number of vats. “Cooks per dispose per vat” information is available. Then global (system level) lifetime cooks per dispose can be calculated as such:

$$Lifetime Cooks Per Dispose = \frac{Σ Cooks per dispose per vat}{{n}_{vats}}$$

Oil Usage Analysis

1. Read from date, to date.

2. Determine time period in number of days, to date-from date+1

3. Determine platform, and associated JIB volume: V_{JIB}. Determine full/split vat volumes: Vf/Vs.

4. Compute system level total number of cooks:
Loop over daily data (i=from date to To Date, i++)
Accumulate total JIB resets:
Zₛ+=JIB resets
   Loop over vat data (j=vat 1 to vat N)
   Xₛ=Total Cooks+=Cooks per vat
   //Accumulate dispose counts between from date to to date over data points.
   If (Dispose per vat)!=0)
      If (Vat is a Full Vat)
      Total Full Vat Dispose+=Y_{F}+=Dispose per vat
      Else
      Total Split Vat Dispose+=Y_{S}+=Dispose per vat

5. Calculate metrics:

Cooks per lb. of oil=Xₛ/V_{JIB}×Zₛ

$$Average Oil Usage per day = \frac{{V}_{F} \times {Y}_{F} + {V}_{s} \times {Y}_{s} + {V}_{JIB} \times {Z}_{s}}{From Date - To Date + 1}$$

//Move on to calculate average days to dispose and average cooks per dispose

6. Find latest dispose event per vat:
Loop over daily data points (i)
Loop over vats (j)
If (There is a dispose event)
nᵥₐₜₛ+=1
Dispose_vats (nᵥₐₜₛ)=j
D2(j)=Date

7. For vats, for which a last dispose date exists (Dispose_vats (nᵥₐₜₛ)) search prior dispose:
Loop over dispose_vats (j)
//Search prior data up to two weeks starting from the last dispose date found per vat. If there is no previous dispose event then exclude respective dispose vat from calculation.
Date=D2(j)
For (i=1 to 14, i++)
If (D1(j) found)
BREAK
If (There is a dispose event)
D1(j)=Date
Vat_Days_To_Dispose(j)=D2(j)−D1(j)
Cooks per dispose (j)+=Cooks
//Accumulate the cook count to use in the calculation of cooks per dispose until D1 is found.
//If a prior dispose event or no dispose event was found within the analysis time period, equal cooks per dispose for the respective vat (jth vat) to zero.
If (No dispose event found):
   If (i=14)
   nᵥₐₜₛ=nᵥₐₜₛ−1
   Vats_Days_To_Dispose(j)=0
   Cooks per dispose (j)=0
8. Calculate average days to dispose and cooks per dispose:
If (nᵥₐₜₛ≥1)
Accumulate over Dispose_vats(nᵥₐₜₛ)

$$Average Days \text{-} To \text{-} Dispose = \frac{{\sum }_{i = 1}^{{n}_{vats}} Vat\_Days \_To \_Dispose ( i )}{{n}_{vats}}$$

$$Average Cooks per Dispose = \frac{{\sum }_{i = 1}^{{n}_{vats}} Cooks\_per \_dispose ( i )}{{n}_{vats}}$$

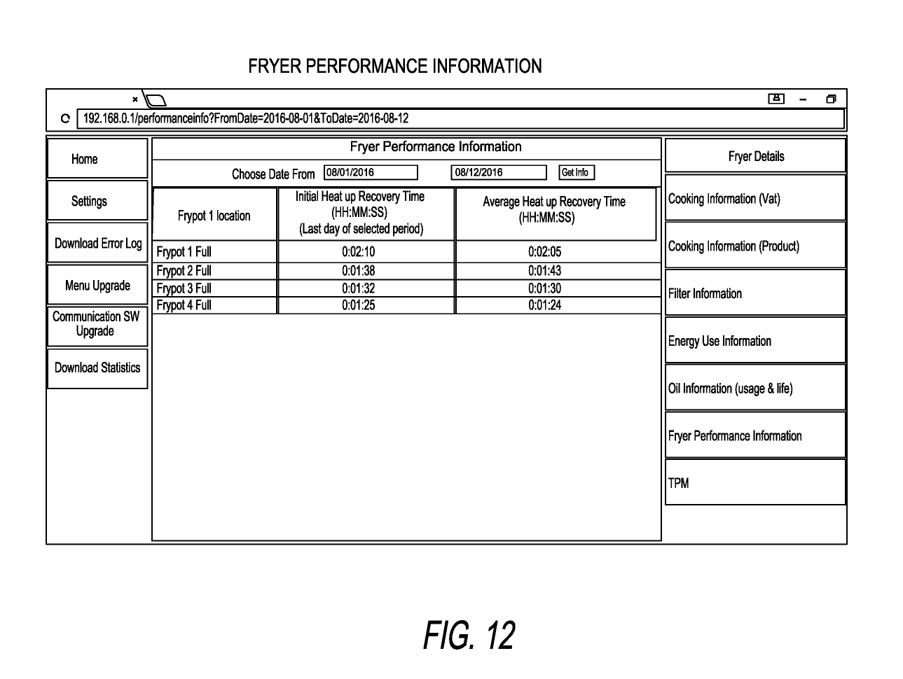

FIG. 12 is a screen shot of dashboard 148, showing fryer performance information. The fryer performance information dashboard page displays the following:

Initial Heat up Recovery Time; and

Average Heat up Recovery Time.

When communication apparatus 110 receives raw data 136 for oil temperature rise during initial heat-up, the messages trigger SUI REST API 305 which then creates a dataset including RTC (Real Time Clock) time/Recovery time, left vat recovery time, right vat recovery time and the vat ID.

Average Heat Up Recovery Time:

Average Heat up Recovery Time is calculated by dividing the time duration of the Recovery time (oil temperature rise from 250F to 300F) by the selected number of days.

$$Average heat up recovery time = \frac{{\sum }_{i = from date}^{to date} total recovery time}{No . of days between selected period}$$

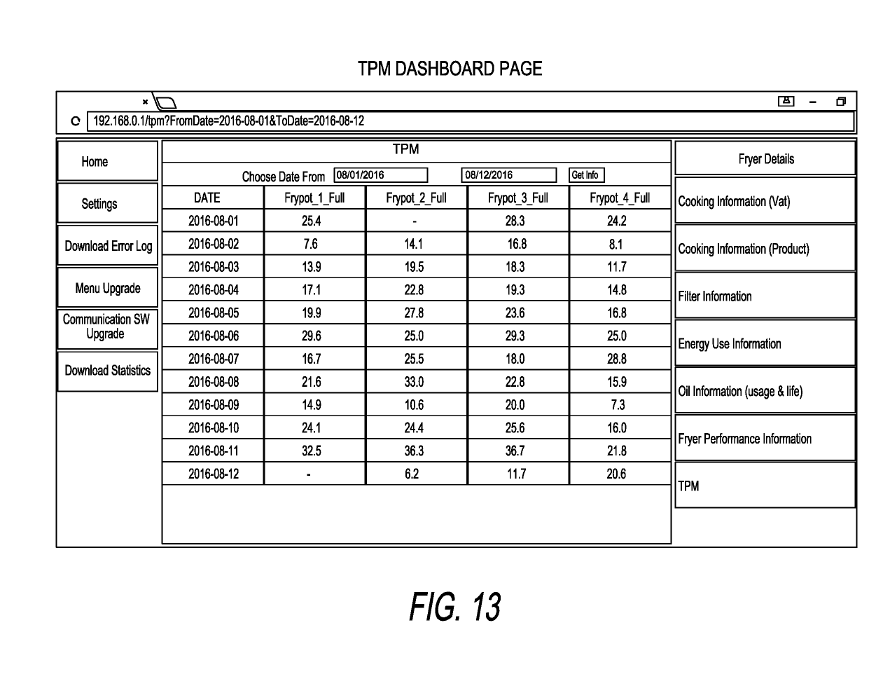

FIG. 13 is a screen shot of dashboard 148, showing Total Polar Materials (TPM). The TPM dashboard page displays information regarding the TPM values for each vat for the selected period.

When communication apparatus 110 receive raw data 136 for TPM, SUI REST API 305 creates an array of data of the TPM values organized by date and vat numbers, within an analysis time frame defined by user 150 in data packet 437.

Thus, program 125 converts machine readable data into human readable form so that service personnel can address issues occurring in appliance 105, and so that a store owner/operator can track key elements such as energy usage, oil usage, types of cooked products, maintenance schedule. Human-readable data can be accessed via a network (e.g., LAN, WAN, Internet) or by manually connecting a USB adapter to communication apparatus 110. The value propositions for system 100 are inherent to the data it provides about the food production, operation and maintenance of appliance 105, such as:

better product quality resulting in operational improvements;

better maintenance of appliance 105 resulting in lower service costs; and

better utilization of energy and food input costs resulting in higher profitability.

Some of the appliances that can serve in the role of appliance 105 are commercial deep-fat fryers, ovens, conveyors, beverage-making machines, beverage-brewing machines, beverage dispensing equipment, refrigerators, ice-making machines, grills, mixers, blenders, product dispensers, and a holding appliance (for food warming or chilling). However, in general, appliance 105 can be any kitchen appliance.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof. The terms “a” and “an” are indefinite articles, and as such, do not preclude embodiments having pluralities of articles.

1. A data communication apparatus adapted for use with a kitchen appliance, comprising:
a bus interface that is adapted for connection to a bus within said kitchen appliance;
a network interface that is addressable at an address in a network;
a processor; and
a memory that contains instructions that are readable by said processor to cause said processor to:
receive, via said bus interface, raw data that represents an operating parameter of said kitchen appliance;
aggregate said raw data over a period of time, thus yielding aggregated data;
receive a request from a user device via said network interface;
analyze said aggregated data, thus yielding an analysis of an operation of said kitchen appliance;
produce a report from said analysis;
incorporate said report into a page that is presentable on said user device via a web browser that is installed in said user device; and
send said page to said user device via said network interface.

2. The data communication apparatus of claim 1, wherein said network interface comprises a wireless communication module.

3. The data communication apparatus of claim 2,
wherein said data communication apparatus further comprises a hardwire communications port, and
wherein said data communication apparatus is adapted to receive said request and send said page by a path selected from the group consisting of said wireless communications module and said hardwire communications port.

4. The data communication apparatus of claim 1,
a port that is adapted to mate with a cable,
wherein said processor is controllable to output said formatted data to an external device via said port.

5. The data communication apparatus of claim 1, wherein said processor configures said page in accordance with a format selected from the group consisting of Extensible Markup Language (XML) and JavaScript Object Notation (JSON).

6. The data communication apparatus of claim 1, wherein said operating parameter is selected from the group consisting of:
(a) a temperature,
(b) a fluid level,
(c) a weight of something,
(d) a quantity of something;
(e) a presence of a gas,
(f) a pressure,
(g) a state of a fluid control mechanism, and
(h) a voltage.

7. The data communication apparatus of claim 1, wherein said data communication apparatus is installed in said kitchen appliance.

8. A kitchen appliance comprising:
a sensor that senses an operating parameter of a component in said kitchen appliance, thus yielding sensory data;
a controller that receives said sensory data, and based thereon, produces a control signal that controls said component;
a network interface that is addressable at an address in a network; and
a processor that:
(a) receives said sensory data;
(b) aggregates said sensory data over a period of time, thus yielding aggregated data; and
(c) in response to a request that is received from a user device via said network interface:
(i) analyzes said aggregated data, thus yielding an analysis of an operation of said kitchen appliance;
(ii) produces a report from said analysis;
(iii) prepares a page that includes said analysis, for a web browser that is installed in said user device; and
(iv) sends said page to said user device via said network interface.

9. The kitchen appliance of claim 8, wherein said network interface comprises a wireless communication module.

10. The kitchen appliance of claim 9, further comprising:
a hardwire communication port,
wherein said processor is adapted to receive said request, and send said page, by a path selected from the group consisting of said wireless communications module and said hardwire communications port.

11. The kitchen appliance of claim 8, further comprising:
a port that is adapted to mate with a cable,
wherein said processor is controllable to output said formatted data to an external device via said port.

12. The kitchen appliance of claim 8, wherein said processor configures said page in accordance with a format selected from the group consisting of Extensible Markup Language (XML) and JavaScript Object Notation (JSON).

13. The kitchen appliance of claim 8, wherein said sensor is selected from the group consisting of:
(a) a temperature sensor,
(b) a fluid level sensor,
(c) a scale that measures a weight of something,
(d) a scale that measures a quantity of something;
(e) a gas sensor,
(f) a pressure sensor,
(g) sensor of a state of a fluid control mechanism, and
(h) a voltage sensor.

14. The data communication apparatus of claim 1, wherein said analysis comprises calculating a quantity of an item produced by said kitchen appliance.

15. The data communication apparatus of claim 1, wherein said analysis comprises calculating a quantity of an item consumed by said kitchen appliance.

16. The data communication apparatus of claim 1, wherein said analysis comprises calculating an amount of utilization of said kitchen appliance.

17. The data communication apparatus of claim 1, wherein said report comprises information regarding a maintenance issue concerning said kitchen appliance.

18. The kitchen appliance of claim 8, wherein said analysis comprises calculating a quantity of an item produced by said kitchen appliance.

19. The kitchen appliance of claim 8, wherein said analysis comprises calculating a quantity of an item consumed by said kitchen appliance.

20. The kitchen appliance of claim 8, wherein said analysis comprises calculating an amount of utilization of said kitchen appliance.
